(19) United States
(12) Patent Application Publication
(10) Pub. No.: US 2012/0114540 A1
(43) Pub. Date: May 10, 2012

(54) METHOD AND APPARATUS FOR REMOVING VOLATILE ORGANIC COMPOUND

(75) Inventors: Sung Min CHIN, Uijeongbu-si (KR); Gwi Nam BAE, Seoul (KR); Jong Soo JURNG, Seoul (KR); Eun Seuk PARK, Seongnam-si (KR)

(73) Assignee: KOREA INSTITUTE OF SCIENCE AND TECHNOLOGY, Seoul (KR)

(21) Appl. No.: 13/013,056

(22) Filed: Jan. 25, 2011

(30) Foreign Application Priority Data
Nov. 9, 2010 (KR) 10-2010-0110890

(51) Int. Cl. B01D 53/44; B01J 19/08

(52) U.S. Cl. 423/245.1; 422/120; 422/122

(57) ABSTRACT

Disclosed is a method for removing volatile organic compounds included in the air, comprising: generating ozone; and treating the ozone with a catalyst to generate reactive species, wherein the volatile organic compounds are decomposed by the reactive species.

### CROSS-REFERENCE TO RELATED APPLICATION

This application claims priority to Korean Patent Application No. 10-2010-0110890, filed on Nov. 9, 2010, and all the benefits accruing therefrom under 35 U.S.C. §119, the contents of which in its entirety are herein incorporated by reference.

### BACKGROUND

1. Field

This disclosure relates to a method and an apparatus for decomposing volatile organic compounds included in the air.

2. Description of the Related Art

Volatile organic compounds (VOCs) are regulated as hazardous air pollutants because they badly affect human health and the environment. Through photochemical reactions, volatile organic compounds produce photochemical oxides such as ozone, which are secondary pollutants. Including a lot of chemicals known to be highly carcinogenic, the volatile organic compounds are harmful to the human body and cause many problems, including destruction of the ozone layer, global warming, photochemical smog and offensive odor, etc.

Available techniques for removing the volatile organic compounds include adsorption using activated carbon, combustion at high temperature, oxidative removal using catalysts, and plasma method.

Adsorption using activated carbon is the most traditional method of removing the volatile organic compounds. In the method, the volatile organic compounds are removed through physical and/or chemical adsorption onto the activated carbon. This method requires frequent exchange of activated carbon because the adsorption does not occur when the activated carbon is saturated. In addition, secondary pollutants may be produced when the used activated carbon is disposed of. Further, it is not appropriate for treatment of highly concentrated volatile organic compounds.

Combustion at high temperature is a method of oxidizing the volatile organic compounds through heating and combustion. This method is effective in removing highly concentrated volatile organic compounds, but is unfavorable for low concentration volatile organic compounds. In addition, the treatment cost is high because auxiliary fuel is necessary.

Oxidative removal using catalysts is a technique wherein an oxidizing catalyst is used to remove the volatile organic compounds through oxidation. Although the catalyst has a long life unlike the activated carbon, the temperature needs to be increased to about 300° C. or more because it is almost inactive at room temperature.

The plasma method is disadvantageous in that another pollutant, i.e., ozone, is generated.

### SUMMARY

The present disclosure is directed to removing volatile organic compounds in the air.

The present disclosure is also directed to removing volatile organic compounds in the air at room temperature.

The present disclosure is also directed to effectively removing not only high concentration volatile organic compounds but also low concentration volatile organic compounds.

The present disclosure is also directed to easily removing volatile organic compounds in the air using a simple facility.

The present disclosure is also directed to safely removing volatile organic compounds without the risk of production of secondary pollutants such as ozone.

In one aspect, there is provided a method for removing volatile organic compounds included in the air, including: generating ozone; and treating the ozone with a catalyst to generate reactive species, wherein the volatile organic compounds are decomposed by the reactive species.

In a method for removing volatile organic compounds according to an embodiment, the amount of ozone to be generated may be determined based on the concentration of the volatile organic compounds in the air.

In a method for removing volatile organic compounds according to another embodiment, the ozone may be generated in an amount of 10 to 15 times the concentration of the volatile organic compounds in the air.

In a method for removing volatile organic compounds according to another embodiment, the volatile organic compounds may be primarily decomposed while generating the ozone.

In a method for removing volatile organic compounds according to another embodiment, the volatile organic compounds may be primarily decomposed using a UV lamp reactor or a plasma reactor while generating the ozone.

In a method for removing volatile organic compounds according to another embodiment, the amount of ozone to be generated may be controlled by controlling the voltage applied to the UV lamp reactor or the plasma reactor.

In another aspect, there is provided an apparatus for removing volatile organic compounds included in the air, including: an ozone generator generating ozone; and a catalyst reacting with the ozone generated by the ozone generator to generate reactive species.

In an apparatus for removing volatile organic compounds according to an embodiment, the catalyst may be provided in the form of a catalytic layer.

In an apparatus for removing volatile organic compounds according to another embodiment, the amount of ozone to be generated by the ozone generator may be determined based on the concentration of the volatile organic compounds in the air.

In an apparatus for removing volatile organic compounds according to another embodiment, the amount of ozone to be generated by the ozone generator may be 10 to 15 times the concentration of the volatile organic compounds in the air.

In an apparatus for removing volatile organic compounds according to another embodiment, the ozone generator may be a UV lamp reactor or a plasma reactor.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 schematically illustrates an apparatus for removing volatile organic compounds according to an embodiment of the present disclosure;

FIG. 2 shows a result of removing toluene according to an embodiment of the present disclosure; and

FIG. 3 shows change in removal efficiency depending on toluene concentration and ozone concentration.

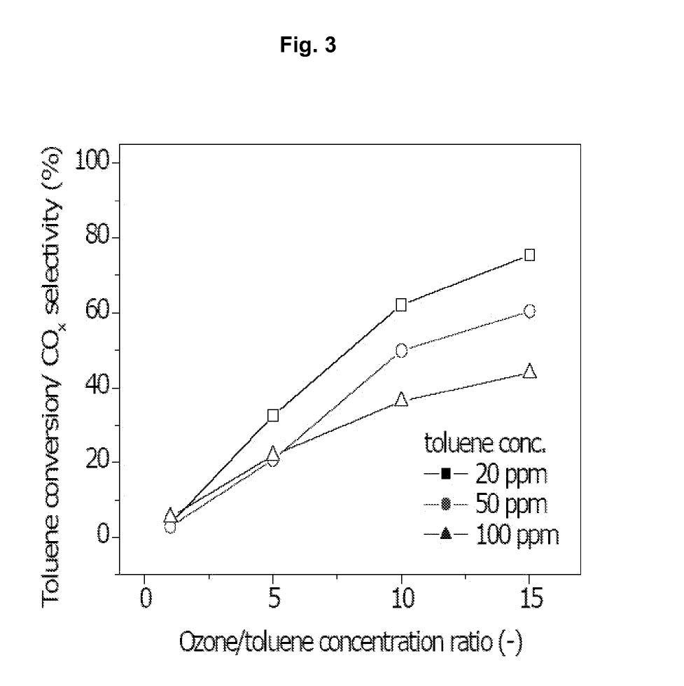

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the “volatile organic compounds (VOCs)” collectively refer to organic chemical compounds which can photochemically react with nitrogen oxides in the air under sunlight to produce oxidative photochemical substances such as ozone and peroxyacyl nitrates (PANs) and induce photochemical smog. They are air pollutants, carcinogenic chemicals with toxicity, and precursors to photochemical oxides. They also cause global warming and offensive odor. Petrochemicals or organic solvents such as benzene, acetylene, gasoline, etc. are included in the volatile organic compounds. They are very diverse, from the solvents commonly used in the industries to organic gases emitted from chemical, pharmaceutical or plastics factories. Almost all hydrocarbons commonly used in daily lives, such as low-boiling-point liquid fuels, paraffins, olefins, aromatic compounds, etc., are included.

The ozone generator may be any ozone generating device known in the art. For example, a UV lamp reactor or a plasma reactor is included. The UV lamp reactor may be a short-wavelength UV lamp reactor. Besides, any known ozone generating device may be used.

The ozone decomposing catalyst may be any catalyst known in the art without particular limitation. For example, Pt, Cr oxide, Al oxide, Co oxide, Cu oxide, Mn oxide, metallic Pd or Pd compounds may be included. For example, a metal oxide such as MnO₂, NiO, CoO, CuO, Fe₂O₃, V₂O₅, AgO₂, etc. may be used. Also, a mixture of several metal oxides may be used. For example, MnO₂—CuO, MnO₂—AgO₂, NiO—CoO—AgO₂, etc. may be used. The catalytic layer may be any one used to decompose ozone known in the art.

The reactive species include various reactive species generated as ozone is decomposed. For example, O(¹D), O(³P) and OH* reactive species may be included.

In a method for removing volatile organic compounds according to another embodiment, the amount of ozone to be generated may be determined based on the concentration of the volatile organic compounds in the air. If the ozone concentration is too low relative to the concentration of the volatile organic compounds, the volatile organic compounds may not be removed effectively because the reactive species are insufficient. And, if the amount of the generated ozone is excessively large, the ozone may not be sufficiently removed by the catalyst and discharged into the air. In this aspect, the concentration of the ozone generated by the ozone generator may be 2 to 50 times, specifically 5 to 30 times, more specifically 10 to 15 times, the concentration of the volatile organic compounds.

The amount the generated ozone may be controlled by controlling the voltage applied to the UV lamp reactor or the plasma reactor. The voltage applied to the UV lamp reactor or the plasma reactor may be controlled manually or automatically. In case of automatic control, the apparatus according to the present disclosure may be set such that the concentration of the volatile organic compounds in the air is measured automatically and the applied voltage is controlled automatically based on the measured concentration. Alternatively, the concentrations of the volatile organic compounds in the air may be previously set at different levels (e.g., high, medium and low) and the voltages appropriate for the levels may also be set previously. In this case, if a user selects the concentration of the volatile organic compounds, e.g., one of high, medium and low levels, the voltage appropriate for the level is applied automatically. Otherwise, the apparatus may be set such that the user directly selects the voltage to be applied. Alternatively, the apparatus of the present disclosure may be provided with the voltages set previously depending on applications, e.g. for home or industrial uses.

When the ozone is generated using the UV lamp reactor or the plasma reactor, polluted air including the volatile organic compounds can be introduced while generating the ozone, so that the volatile organic compounds may be primarily decomposed while the ozone is generated. The primarily decomposed air including the volatile organic compounds is secondarily decomposed by the ozone-decomposing reactive species while it passes through the catalytic layer. Alternatively, the polluted air may be directly introduced to the catalytic layer without passing through the ozone generator.

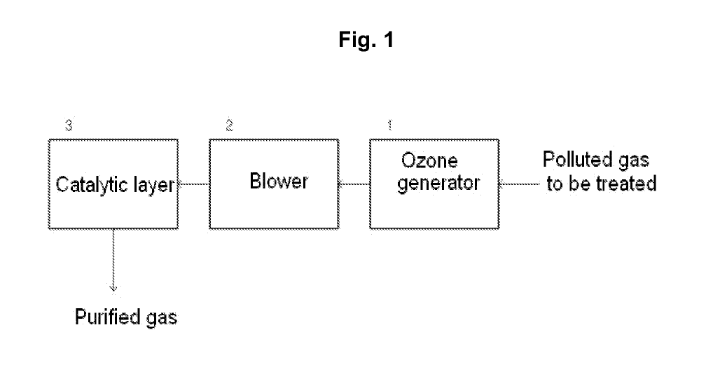

FIG. 1 schematically illustrates an apparatus for removing volatile organic compounds according to an embodiment of the present disclosure. Volatile organic compounds included in polluted air are primarily oxidized and removed by an ozone generator 1 embodied as a short-wavelength UV lamp reactor or a plasma reactor. The concentration of ozone generated by the ozone generator is maintained at 10 to 15 times the concentration of the volatile organic compounds. The ozone concentration may be controlled by controlling the voltage applied to the short-wavelength UV lamp reactor or the plasma reactor. The volatile organic compounds remaining without being removed by the ozone generator are finally oxidized and removed by the reactive species generated from the decomposition of the ozone generated by the ozone generator as it passes through a catalytic layer 3. Since the catalytic layer 3 contains a catalyst that oxidizes and removes the ozone, ozone is not included in the finally discharged gas stream.

### EXAMPLES

The examples (and experiments) will now be described. The following examples (and experiments) are for illustrative purposes only and not intended to limit the scope of the present disclosure.

### Example 1

Toluene, a typical volatile organic compound, was removed using the apparatus for removing volatile organic compounds illustrated in FIG. 1. The concentration of toluene in the air introduced to the apparatus for removing volatile organic compounds was 50 ppm. The air inflow rate was 0.4 L/min, and the residence time of the air in the catalytic layer was 0.18 second (GHSV=20000/hr). The concentration of ozone generated from the ozone generator (LAB-2, Ozone Tech) was 450 ppm, about 10 times the toluene concentration, and the temperature of the catalytic layer was room temperature (25° C.).

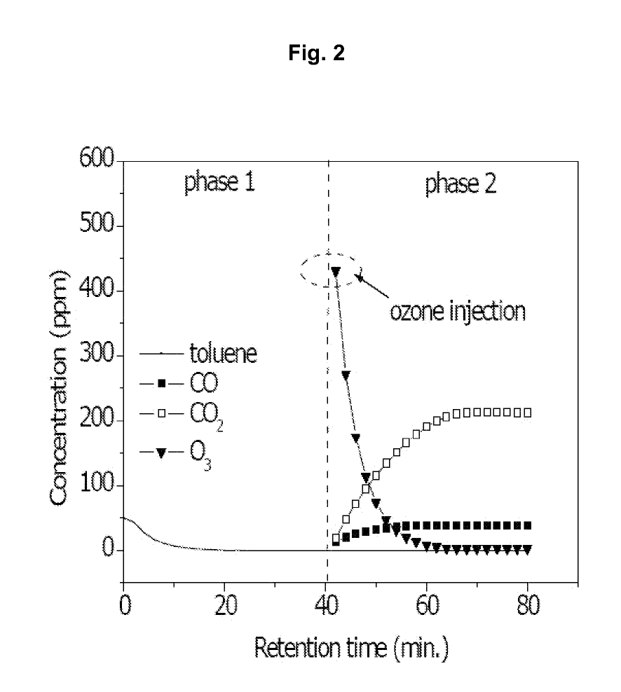

The result is shown in FIG. 2. In “phase 1”, wherein only 50 ppm toluene was passed through the catalytic layer, the toluene concentration decreased to 0 ppm at 20 minutes as toluene was continuously adsorbed on the catalytic layer. However, the adsorption does not permanently remove the toluene but temporarily holds it in the catalytic layer. Thus, when only toluene was passed through the catalytic layer, toluene was not adsorbed any more after 2 hours.

In contrast, in “phase 2”, wherein 450 ppm of ozone was passed through the catalytic layer, the ozone concentration decreased rapidly as the ozone was decomposed in the catalytic layer. From about 20 minutes, no more ozone was detected, and, at the same time, the concentrations of CO and CO₂ increased consistently as the toluene adsorbed to the catalytic layer was decomposed to CO or CO₂.

### Example 2

The effect of the ratio of the concentration of the volatile organic compounds and the ozone concentration on the removal efficiency of the volatile organic compounds was investigated. For this, air polluted with toluene was treated under the same condition as Example 1 using the apparatus for removing volatile organic compounds illustrated in FIG. 1. With the toluene concentration fixed at 20, 50 or 100 ppm, toluene conversion and COx selectivity were investigated while increasing the ozone/toluene concentration ratio from 1.0 to 15.0. The toluene conversion resulting from the adsorption of the toluene to the catalytic layer decreased gradually as the toluene concentration increased, which is a typical adsorption pattern showing the inversely proportional relationship between the toluene concentration and the adsorption performance. Meanwhile, the COx selectivity increased as the ozone concentration increased, because the concentration of the reactive species generated from the catalytic layer increased. Thus, it can be seen that sufficient reactive species are generated from the catalytic layer when the ozone concentration is above a predetermined level and the toluene can be oxidized and decomposed by them.

In accordance with the present disclosure, volatile organic compounds in the air may be removed at room temperature. Further, not only high concentration volatile organic compounds but also low concentration volatile organic compounds may be effectively removed. In addition, volatile organic compounds in the air may be removed easily using a simple facility. Further, volatile organic compounds may be safely removed without the risk of production of secondary pollutants such as ozone. The oxidizing effect is superior even when the residence time in the catalytic layer is short. By controlling the amount of ozone to be generated, air polluted with various contaminants at various concentrations may be effectively treated. Requiring small installation space, being applicable to air polluted at low concentration, and allowing easy removal of pollutants at room temperature, the present disclosure may perfectly remove indoor air pollutants and adequately cope with the sick building syndrome.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method for removing volatile organic compounds included in the air, comprising:
generating ozone; and
treating the ozone with a catalyst to generate reactive species,
wherein the volatile organic compounds are decomposed by the reactive species.

2. The method for removing volatile organic compounds according to claim 1, wherein said generating ozone comprises determining the amount of ozone to be generated based on the concentration of the volatile organic compounds in the air.

3. The method for removing volatile organic compounds according to claim 2, wherein said generating ozone comprises generating ozone in an amount of 10 to 15 times the concentration of the volatile organic compounds in the air.

4. The method for removing volatile organic compounds according to claim 1, wherein said generating ozone comprises primarily decomposing the volatile organic compounds while generating the ozone.

5. The method for removing volatile organic compounds according to claim 4, wherein said generating ozone comprises primarily decomposing the volatile organic compounds using a UV lamp reactor or a plasma reactor while generating the ozone.

6. The method for removing volatile organic compounds according to claim 5, wherein said generating ozone comprises controlling the amount of ozone to be generated by controlling the voltage applied to the UV lamp reactor or the plasma reactor.

7. An apparatus for removing volatile organic compounds included in the air, comprising:
an ozone generator generating ozone; and
a catalyst reacting with the ozone generated by the ozone generator to generate reactive species.

8. The volatile organic compound treating device according to claim 7, wherein the catalyst is provided in the form of a catalytic layer.

9. The volatile organic compound treating device according to claim 7, wherein the amount of ozone to be generated by the ozone generator is determined based on the concentration of the volatile organic compounds in the air.

10. The volatile organic compound treating device according to claim 9, wherein the amount of ozone to be generated by the ozone generator is 10 to 15 times the concentration of the volatile organic compounds in the air.

11. The volatile organic compound treating device according to claim 7, wherein the ozone generator is a UV lamp reactor or a plasma reactor.
